(19) United States
(12) Patent Application Publication
(10) Pub. No.: US 2024/0094170 A1
(43) Pub. Date: Mar. 21, 2024

(54) SYSTEMS AND METHODS FOR CALIBRATING TRANSDUCERS USED FOR ACOUSTIC SIGNAL ANALYSIS OF BATTERIES

(71) Applicant: Liminal Insights, Inc., Emeryville, CA (US)

(72) Inventors: Austin Ryan DULANEY, Emeryville, CA (US); Shaurjo BISWAS, El Cerrito, CA (US); Daniela Alejandra ESPARZA CABRERA, Emeryville, CA (US)

(73) Assignee: Liminal Insights, Inc., Emeryville, CA (US)

(21) Appl. No.: 18/369,422

(22) Filed: Sep. 18, 2023

Related U.S. Application Data
(60) Provisional application No. 63/376,200, filed on Sep. 19, 2022.

(51) Int. Cl. G01N 29/44

(52) U.S. Cl. CPC G01N 29/4463

(57) ABSTRACT

Systems, techniques, and computer-implemented processes for calibration of transducers used for acoustic signal-based analysis are disclosed. In one aspect, a calibration method includes capturing a plurality of signals for a plurality of channels, each of the plurality of channels being associated with a pair of transducers formed of a transmitting transducer and a receiving transducer; and for each of the plurality of channels, determining a corresponding peak intensity for a corresponding signal of the plurality of signals; normalizing the corresponding signal based at least on the corresponding peak intensity to yield a corresponding normalized signal; and applying a time-shift to the normalized signal.

### CROSS-REFERENCE TO RELATED APPLICATIONS

This application claims the benefit of priority to U.S. provisional application No. 63/376,200, filed on Sep. 19, 2022, entitled SYSTEMS AND METHODS FOR CALIBRATING TRANSDUCERS USED FOR ACOUSTIC SIGNAL ANALYSIS OF BATTERIES, which is expressly incorporated by reference herein in its entirety.

### FIELD OF DISCLOSURE

The present disclosure is directed to systems used for monitoring and inspection of batteries based on acoustic signals. More specifically, exemplary aspects are directed to calibration of transducers used for acoustic signal analysis of batteries.

### BACKGROUND

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

### BRIEF DESCRIPTION OF THE DRAWINGS

The accompanying drawings are presented to aid in the description of various aspects of the disclosure and are provided solely for illustration and not limitation.

FIG. 1 illustrates an example system for analyzing a sample using acoustic signal-based analysis, according to some aspects of the present disclosure;

FIG. 2 illustrates another example system for analyzing a sample using acoustic signal-based analysis, according to some aspects of the present disclosure;

FIG. 3 illustrates an example output for a number of transducer channels;

FIG. 4 is a flow chart of an example method of signal processing-based calibration of transducers, according to some aspects of the present disclosure;

FIG. 5 is an example of normalized intensity for channel signals of FIG. 3, according to some aspects of the present disclosure; and

FIG. 6 illustrates an example computing device architecture of an example computing device, in accordance with some aspects of the disclosure.

### SUMMARY

The present disclosure provides an alternative approach for digital, and signal-processing based calibration method for calibrating transducers. The disclosure begins with a discussion of example apparatuses and systems for analyzing a sample such as a battery cell using acoustic signal-based analysis.

In one aspect, a calibration method includes capturing a plurality of signals for a plurality of channels, each of the plurality of channels being associated with a pair of transducers formed of a transmitting transducer and a receiving transducer; and for each of the plurality of channels, determining a corresponding peak intensity for a corresponding signal of the plurality of signals; normalizing the corresponding signal based at least on the corresponding peak intensity to yield a corresponding normalized signal; and applying a time-shift to the normalized signal.

In another aspect, completing the determining, the normalizing and the applying steps for each of the plurality of channels, reduces a variation in signal intensity across the plurality of channels to be within a threshold.

In another aspect, normalizing the corresponding signal is based on the peak intensity and a scalar factor.

In another aspect, applying the scalar factor to the corresponding peak intensity of each of the plurality of channels results in the same peak intensity across the plurality of channels.

In another aspect, applying the time-shift includes determining a timestamp of a corresponding first dip of the corresponding normalized signal, the time-shift being equal to a difference between measured time of the first dip and an expected value of the time of the first dip.

In another aspect, the calibration method is performed in a time domain.

In another aspect, the calibration method is performed for a plurality of pairs of transducers utilized in a testing device for determining a state of health and a state of charge of batteries.

In another aspect, the calibration method is a digital calibration method performed remotely relative to the testing device.

In another aspect, the calibration method is performed periodically upon detecting a triggering condition.

In one aspect, a device is configured to calibrate a plurality of transducers, the device includes one or more memories having computer-readable instructions stored therein and one or more processors. The one or more processors are configured to execute the computer-readable instructions to capture a plurality of signals for a plurality of channels, each of the plurality of channels being associated with a pair of transducers formed of a transmitting transducer and a receiving transducer; determine a corresponding peak intensity for a corresponding signal of the plurality of signals; normalize the corresponding signal based at least on the corresponding peak intensity to yield a corresponding normalized signal; and apply a time-shift to the normalized signal.

In another aspect, determining the corresponding peak intensity, normalizing the corresponding signal, and applying the time-shift for each of the plurality of channels, results in reducing a variation in signal intensity across the plurality of channels to be within a threshold.

In another aspect, the one or more processors are configured to normalize the corresponding signal based on the peak intensity and a scalar factor.

In another aspect, the one or more processors are configured to apply the scalar factor to the corresponding peak intensity of each of the plurality of channels to obtain the same peak intensity across the plurality of channels.

In another aspect, one or more processors are configured to apply the time-shift by determining a timestamp of a corresponding first dip of the corresponding normalized signal, a difference between measured time of the first dip and an expected value of the time of the first dip.

In another aspect, the one or more processors are configured to perform calibration of the plurality of transducers in a time domain.

In another aspect, the plurality of transducers are utilized in a testing device for determining a state of health and a state of charge of batteries.

In another aspect, the one or more processors are configured to digitally calibrate the plurality of transducers.

In another aspect, the one or more processors are configured to periodically calibrate the plurality of transducers upon detecting a triggering condition.

In one aspect, one or more non-transitory computer-readable media include computer-readable instructions, which when executed by one or more processors, cause the one or more processors to capture a plurality of signals for a plurality of channels, each of the plurality of channels being associated with a pair of transducers formed of a transmitting transducer and a receiving transducer; determine a corresponding peak intensity for a corresponding signal of the plurality of signals; normalize the corresponding signal based at least on the corresponding peak intensity to yield a corresponding normalized signal; and apply a time-shift to the normalized signal.

In another aspect, determining the corresponding peak intensity, normalizing the corresponding signal, and applying the time-shift for each of the plurality of channels, results in reducing a variation in signal intensity across the plurality of channels to be within a threshold.

### DETAILED DESCRIPTION

Certain aspects and embodiments of this disclosure are provided in the following description and related drawings. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

An example of such technological advances includes systems and processes for non-invasive and non-destructive analysis of battery cells using acoustic signal-based analysis, whereby acoustic signals are transmitted through one or more battery cells under testing and the received signals are analyzed using various known or to be developed data analytics techniques to assess the physical properties of battery cells and components thereof including state of health, state of charge, battery cell life expectancy, etc. Furthermore, data analytics on signals obtained by ultrasound propagation through materials inside battery cells can be used to analyze electrode slurry parameters including slurry density, trapped air content, viscosity, and uniformity of mixture. In some examples, using the disclosed techniques in battery manufacturing and production can lead to reduction in waste of damaged/scrapped battery cells and shorten production time.

As noted, this non-invasive process relies on transmission and reception of acoustic signals through battery cell(s) under testing. The transmission and reception of acoustics signals are enabled using one or more arrays of transducers structured and configured to operate as transmitters and receivers of acoustic signals. In a perfect world, transducers are all the same in a sense that they all transmit the same signal (as transmitters) and receive the same (as receivers). Accordingly, in such perfect world, any two transducers may be paired (one operating and a transmitter of acoustic signals and the other as a received of transmitted signals) and variations in signal quality across each pair of transducers used in a testing device is zero to ensure consistency in the acoustic data captured for the battery cell under testing.

However, due to the structure of transducers and their inherent characteristics, transducers exhibit variations. As a matter of fact, off-the-shelf transducers exhibit approximately a 10% variation along an average centroid frequency of the transducers. For example, if randomly selected transducers, from a pool of purchased off-the-shelf transducers, are paired to form 10, 15, or 20 pairs of transducers used within a battery testing apparatus, variation across any two pairs of transducers would be approximately 10% or more. This has forced manufacturers of battery testing apparatuses to use a brute force calibration method of mixing and matching transducers manually to reduce this variation significantly. Due to the sensitive nature of acoustic signal-based analysis of battery cells, such variation needs to be significantly lower (e.g., equal to or less than 2%). This brute force is a time consuming and expensive method that is also prone to human errors and does not guarantee that variations among transducers can be reduced to a satisfactory level (e.g., to be equal to or less than 2%). Moreover, the characteristics of individual transducers can drift over time, resulting in variations in one or more transducers to fall out of specification for applications in battery cell analyses

The present disclosure provides an alternative approach for digital, and signal-processing based calibration method for calibrating transducers to reduce variations in signal intensity across all channels and increase signal similarity, as measured by cross correlation. The disclosure begins with a discussion of example apparatuses and systems for analyzing a sample such as a battery cell using acoustic signal-based analysis. The calibration method and example embodiments thereof described herein can be used for determining state of health and/or state of charge of batteries, determining electrolyte saturation quality during battery manufacturing, formation quality during battery manufacturing, and cycle life prediction (battery cell life expectancy), quality of cell manufacturing process steps, outbound/inbound quality control, module/pack manufacturing, etc.

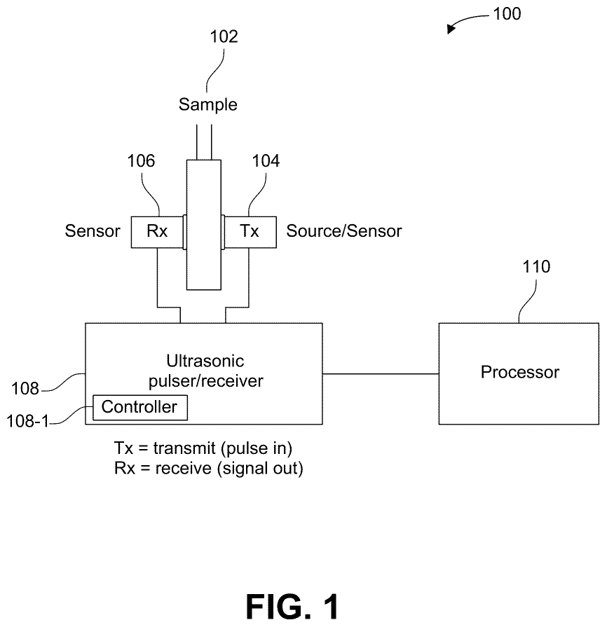

FIG. 1 illustrates an example system for analyzing a sample using acoustic signal-based analysis, according to some aspects of the present disclosure. System 100 may include sample 102. Sample 102 can include a battery cell or component thereof in any stage of production or manufacture of the battery cell or the individual components. In some examples, sample 102 can include a battery cell, electrolytes in various stages of wetting/distribution through a battery cell, one or more electrodes of the battery cell, thin films, separators, coated sheets, current collectors, electrode slurries, or materials for forming any of the above components during any stage of their formation. System 100 can include a transmitting transducer Tx 104 or other means for sending excitation sound signals into the battery cell (e.g., for transmitting a pulse or pulses of ultrasonic or other acoustic waves, vibrations, resonance measurements, etc., through the battery cell). System 100 can further include a receiving transducer Rx 106 or other means for receiving/sensing the sound signals, which can receive response signals generated from signals transmitted by Tx transducer 104. Any type of known or to be developed transducer for transmitting and receiving acoustic signals may be used as Tx transducer 104. Transmitted signals from Tx transducer 104, from one side of sample 102 on which Tx transducer 104 is located, may include input excitation signals. Reflected signals, e.g., from another side of sample 102, may include echo signals. It is understood that references to response signals may include both the input excitation signals and the echo signals. Further, Tx transducer 104 may also be configured to receive response signals, and similarly, Rx transducer 106 may also be configured to transmit acoustic signals. Any type of known or to be developed transducer for transmitting and receiving acoustic signals may be used as Rx transducer 106. Therefore, even though separately illustrated as Tx and Rx, the functionalities of these transducers may be for both sending and receiving acoustic signals. In various alternatives, even if not specifically illustrated, one or more Tx transducers and one or more Rx transducers can be placed on the same side or wall of sample 102, or on different (e.g., opposite) sides. Throughout this disclosure, reference may be made to a transducer pair (a transmitting transducer and a receiving transducer). Transducer Tx 104 and transducer Rx 106 may form a pair of transducers.

Acoustic pulser/receiver 108 can be coupled to Tx and Rx transducers 104, 106 for controlling the transmission of acoustic signals (e.g., ultrasound signals) and receiving response signals. Acoustic pulser/receiver 108 may include a controller 108-1 for adjusting the amplitude, frequency, and/or other signal features of the transmitted signals. Acoustic pulser/receiver 108 may also receive the signals from Rx transducers 106. In some examples, acoustic pulser/receiver 108 may be configured as a combined unit, while in some examples, an acoustic pulser for transmitting excitation signals through Tx transducer 104 can be a separate unit in communication with a receiver for receiving signals from Rx transducer 106. Processor 110 in communication with acoustic pulser/receiver 108 may be configured to store and analyze the response signal waveforms according to this disclosure. Although representatively shown as a single processor, processor 110 can include one or more processors, including remote processors, cloud computing infrastructure, etc.

Although not explicitly shown in FIG. 1, more than one Tx transducer and/or more than one Rx transducer can be placed in one or more spatial locations across sample 102. This allows studying a spatial variation of acoustic signal features across sample 102. A multiplexer can be configured in communication with the acoustic pulser/receiver 108 for separating and channeling the excitation signals to be transmitted and the response signals received. In some examples, various acoustic couplants can be used (e.g., solid, liquid, or combinations thereof) for making or enhancing contact between Tx and Rx transducers 104, 106 and sample 102. Furthermore, various attachment or fixturing mechanisms (e.g., pneumatic, compression, screws, etc.) can also be used for establishing or enhancing the contact between Tx and Rx transducers 104, 106 and sample 102.

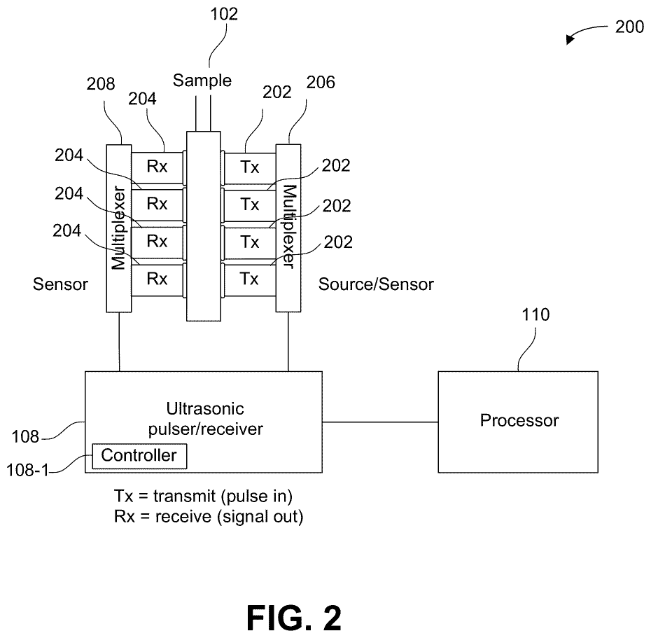

FIG. 2 illustrates another example system for analyzing a sample using acoustic signal-based analysis, according to some aspects of the present disclosure. In comparison with FIG. 1, system 200 of FIG. 2 illustrates a system in which multiple pairs of transmitting and receiving transducers are used for transmitting signals through a sample under testing (e.g., a battery cell) and performing acoustic signal-based analysis of the sample.

System 200 includes several transmitting Tx transducers 202 (each of which may be the same as Tx transducer 104 of FIG. 1). While an array of four examples Tx transducers 202 are shown in FIG. 2, the disclosure is not limited to four. Any number of transducers may be used (e.g., any number of Tx transducers ranging from 1 to 10, 15, 20, etc.).

Similarly, system 200 includes a number of receiving (sensing) Rx transducers 204 (each of which may be the same as Rx transducer 106 of FIG. 1). While an array of four examples Rx transducers 204 are shown in FIG. 2, the disclosure is not limited to four. Any number of transducers may be used (e.g., any number of Rx transducers ranging from 1 to 10, 15, 20, etc.). Any given Tx transducer 202 and Rx transducer 204 may form a transducer pair (FIG. 2 illustrates four transducer pairs). FIG. 2 also illustrates a multiplexer 206 coupled to the array of four Tx transducers 202 and a multiplexer 208 coupled to the array of four Rx transducers 204. As described above, each one of multiplexers 206 and 208 may be configured in communication with the acoustic pulser/receiver 108 for separating and channeling the excitation signals to be transmitted and the response signals received, respectively. In some examples, various acoustic couplants can be used (e.g., solid, liquid, or combinations thereof) for making or enhancing contact between Tx and Rx transducers 202, 204 and sample 102. Furthermore, various attachment or fixturing mechanisms (e.g., pneumatic, compression, screws, etc.) can also be used for establishing or enhancing the contact between Tx and Rx transducers 202, 204 and sample 102.

Spacing between Tx transducers 202 and Rx transducers 204 may be uniform and the same. System 200 also includes additional elements such as sample 102, ultrasonic pulser/receiver 108 (controller 108-1), processors 110, each of which may be the same as the corresponding counterpart described above with reference to FIG. 1 and hence will not be described further for sake of brevity.

As noted above, due to the structure of transducers and their inherent characteristics, transducers exhibit variations in transmitted and received signals. As a matter of fact, off-the-shelf transducers exhibit approximately a 10% variation along an average centroid frequency of the transducers. For example, if randomly selected transducers, from a pool of purchased off-the-shelf transducers, are paired to form 10, 15, or 20 pairs of transducers used within a battery testing apparatus, variation across any two pairs of transducers would be approximately 10% or more. This variation has forced manufacturers of battery testing apparatuses to use a brute force calibration method of mixing and matching transducers manually to reduce this variation significantly. Due to the sensitive nature of acoustic signal-based analysis of batteries, such variation needs to be significantly lower (e.g., equal to or less than 2%). This is a time consuming and expensive method that is also prone to human errors. Moreover, any physical movement of a testing system such as systems 100 and 200 of FIGS. 1 and 2, may result in loss of calibration.

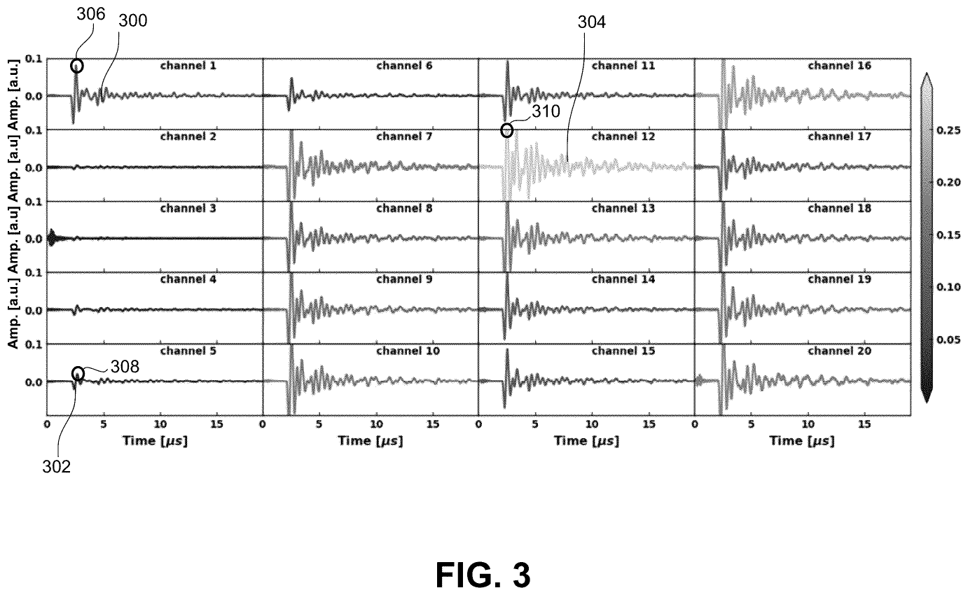

FIG. 3 illustrates an example output for a number of transducer channels. More specifically, FIG. 3 illustrates an output across 20 channels. Each channel may correspond to one pair of Tx and Rx transducers such as a pair of Tx and Rx transducers 202 and 204 that may be positioned opposite each other in an array of transducers (sensors). The time-domain output of each channel is shown in FIG. 3. In one example, this output is obtained after the brute force method of manually mixing and matching Tx and Rx transducers in an attempt to reduce variations in outputs of different channels and increase signal similarity, as measured by cross correlation. However, as shown, the variation is still quite strong. For example, output of channel 1 300 is very different than output of channel 5 302 or channel 12 304, etc.

With example systems described above with reference to FIGS. 1 and 2, the discussion now turns to example methods for digital and signal-processing based calibration of transducers.

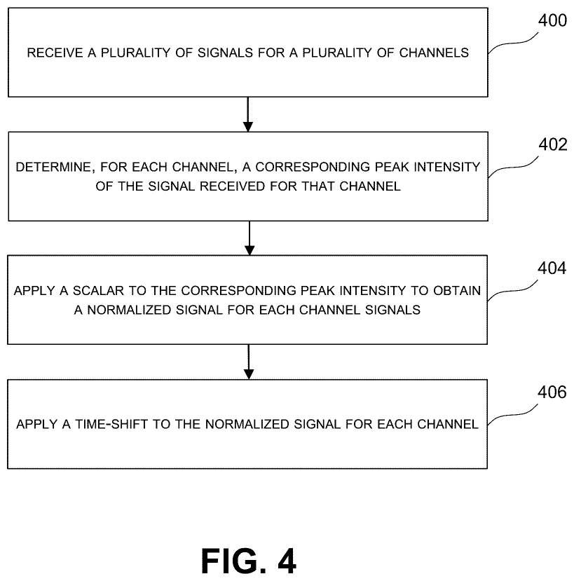

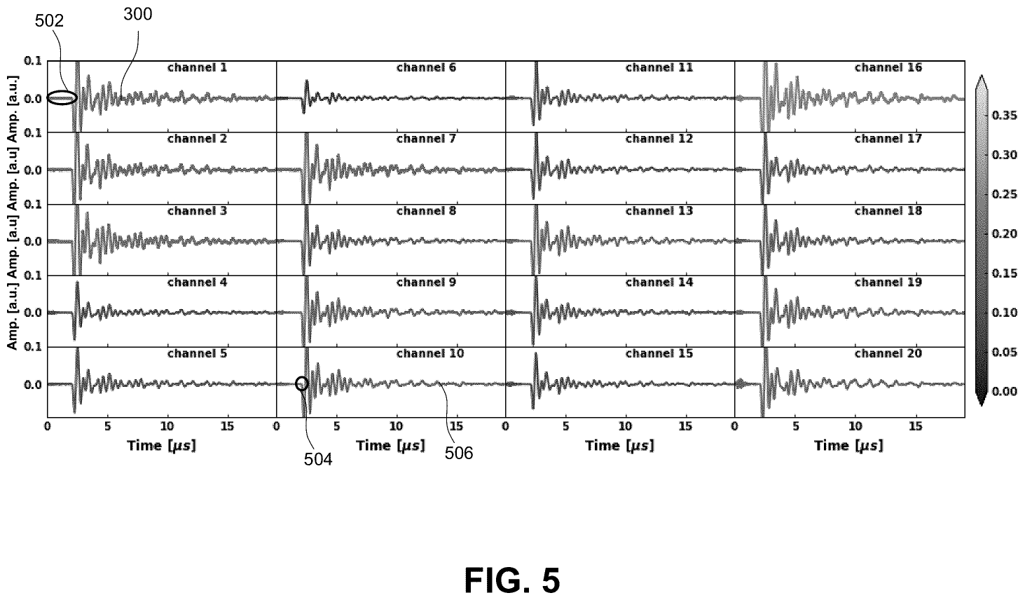

FIG. 4 is a flow chart of an example method of signal processing-based calibration of transducers, according to some aspects of the present disclosure. The process of FIG. 4 will be described from the perspective of processor 110 of FIGS. 1 and 2. It should be understood that processor 110 may be configured to execute computer-readable instructions stored in one or more associated memories to implement the steps of FIG. 4. In describing FIG. 4, references may be made to FIG. 3 and FIG. 5.

At step 400, processor 110 may receive a plurality of signals for a plurality of channels. In one example, processor 110 may control ultrasonic pulser/receiver 108 to send excitation signals through each Tx transducer 202 and receive the response signal captured by a corresponding one of Rx transducers 204. Each of the plurality of channels may correspond to (be associated with) a pair of Tx and Rx transducers. For instance, system 200 of FIG. 2 would have 4 channels each corresponding to one of the four pairs of transducers shown therein.

At step 402, processor 110 may determine, for each channel, a corresponding peak intensity of the signal received for that channel. In one example, a peak intensity would be the value of the highest peak of the received signal for that channel (e.g., peak intensity 306 of channel 1 300, peak intensity 308 of channel 5 302, peak intensity 310 of channel 12 304, etc., as shown in FIG. 3).

At step 404, processor 110 may apply a scalar to the corresponding peak intensity determined for each channel. In one example, processor 110 may multiply the peak intensity value of each channel (e.g., each of the 20 peak intensity values for the 20 channels shown in example of FIG. 3) by such scalar such that the peak intensity of each channel is the same across all channels after being multiplied by the scalar (e.g., when the channels are being used to measure an identical piece of material). In one example, the scalar may be a configurable parameter determined based on experiments and/or empirical studies.

In one example, by performing steps 402 and 404, processor 110 may be said to have normalized (standardized) the intensity of all channels for which the signals are received at step 400.

FIG. 5 is an example of normalized intensity for channel signals of FIG. 3, according to some aspects of the present disclosure. Comparing the output shown in FIG. 5 to that of FIG. 3 shows a significantly more normalized output (normalized signal intensity) across the 20 channels with lower variations in between compared to that shown in FIG. 3.

Referring back to FIG. 4, at step 406, processor 110 may apply a time shift to the normalized signal for each channel. In one example, the time shift applied may be equal to a mean of the time a first signal through a sample is received at a Rx transducer for the corresponding channel. For example, when a Tx transducer emits a signal to pass through a sample under testing, it will take a period of time (e.g., a few microseconds) for the signal that has passed through the sample to reach the corresponding Rx transducer and hence be recorded. The signal recorded for this period of time, before the signal through the sample is received, may typically be noise and is indicated by the initial part of the recorded signal of each channel (flat and near zero). An example of this would be portion 502 of channel 1 300 shown in FIG. 5. For each channel, the first dip is indicative of an actual signal through a sample received by a corresponding Rx transducer and recorded. For example, a first dip 504 of channel 10 506 is shown in FIG. 5.

In one example, instead of taking a single value of the first dip, a mean of several signals transmitted through a given sample of a particular type, may be determined and used as the time of the first dip (timestamp of a corresponding first dip), by which each normalized signal shown in FIG. 5 is time shifted. For instance, a particular sample of a given shape, size, and/or thickness, may have multiple instances of signals transmitted therethrough and recorded. For example, a system such as system 100 or 200 of FIGS. 1 and 2, may have 20 pairs of transducers with sample 102 placed therein for testing. Multiple signals may be transmitted through sample 102 and recorded. For each recording, the time of the first dip for each channel is recorded. Furthermore, the expected value of the time of the first dip is determined. This expected value may be determined through recording the dip time for a statistically significant sample size of transducer pairs and taking the mean of the measured dip times. Thereafter, the measured and expected values of the first dip may be used to normalize the output of each channel. In one example, the output of each channel is normalized by performing a time-shift, where the time-shift is equal to a difference between the measured time (measured timestamp) of the first dip and the expected value of the first dip (expected value of the timestamp of the first dip).

In one example, steps 402, 404, and 406 may collectively be referred to as a process of calibrating (digital or signal processing-based calibrating) of transducer pairs.

In describing the existing brute force method of manually mixing and matching transducers above, it was mentioned that current transducer variations is around 10%. This means that if a time-domain recording of a channel utilizing such transducers (e.g., the time-domain recordings of channels 1-20 shown in FIG. 3) are transformed into the frequency domain (e.g., using Fast Fourier Transform), there would be about a 10% variation between the centroid frequencies of the 20 channels. After the digital/signal processing-based calibration of FIG. 4 is applied to the inherent transducer variations recorded (e.g., in FIG. 3), the variation between the centroid frequencies of the 20 channels shown in FIG. 5 would be approximately around the desired 2% threshold for the sensitive application of acoustic signal-based analysis of battery cells.

In some examples, the process of digital and signal processing-based calibration of transducer pairs may be performed automatically upon occurrence of a triggering condition. For instance, state of channel responses of all channels may be continuously monitored (e.g., by processor 110). When a drift on a first break time and signal peak is observed, the signal processing-based calibration process of FIG. 4 may be triggered, and transducer pairs are automatically calibrated. In one example, a drift would be the expected time of receiving a response signal from each channel. In some examples, such drift can be detected as a statistically significant deviation from the expected value of the time of receiving a signal. For instance, if the expected value of the first break of 10 μs (i.e., 10 μs after a transmitted signal is received at a receiving transducer), then a deviation of 2% from 10 μs (e.g., a measurement with 9.8 μs or 10.2 μs) would trigger the calibration. The deviation threshold may be a configurable parameter determined based on experiments and/or empirical studies.

In some examples, a drift may be detected through regular/routine measurements on a standard material sample.

In another example, calibration may be triggered periodically (e.g., based on a time interval). For example, transducer calibration according to examples described herein may be triggered once a week, once a month, etc. The periodicity may be determined based on experiments and/or empirical studies.

This process may ensure inter and intra system reliability resulting in consistency of performance across all systems such as systems 100 and 200 of FIG. 2.

There are one or more advantages to the digital/signal processing-based calibration method of the present disclosure. For example, because the calibration method is signal processing-based instead of mechanical, the calibration of transducers of a given testing system such as systems 100 and 200 of FIGS. 1 and 2, can be performed remotely and/or periodically. Therefore, systems may no longer suffer from losing calibration during transportation as the transducer pairs can be remotely calibrated upon arrival at a designated destination. Moreover, system usage may cause drifts over time and hence loss of calibration. This loss of calibration and/or troubleshooting can be frequency addressed using the calibration method of the present disclosure and done so remotely.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Accordingly, an aspect of the invention can include a computer-readable media embodying a method of improvements to one or more processes in the manufacturing of battery cells using acoustic signal-based analysis. Accordingly, the invention is not limited to illustrated examples and any means for performing the functionality described herein are included in aspects of the invention.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process of FIG. 4 is illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process of FIG. 4 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

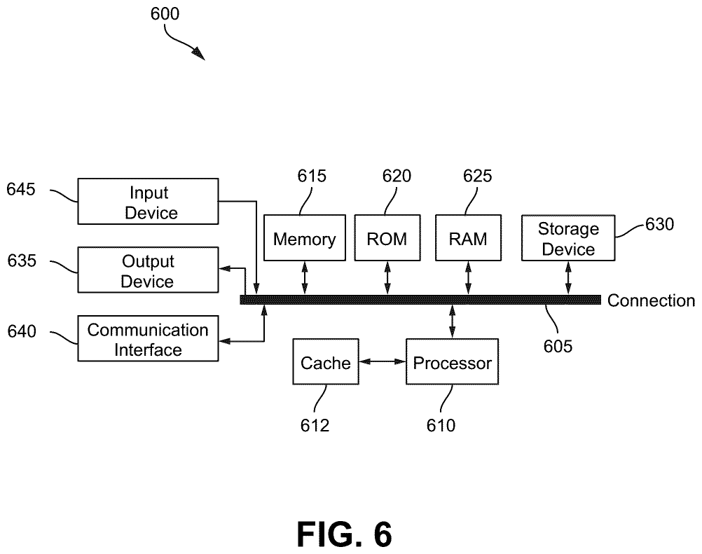

FIG. 6 illustrates an example computing device architecture of an example computing device, in accordance with some aspects of the disclosure. Device architecture 600 of an example computing device which can be used as various components of system 100 or 200 (e.g., processor 110) implement various techniques described herein. The components of the computing device architecture 600 are shown in electrical communication with each other using a connection 605, such as a bus. The example computing device architecture 600 includes a processing unit (CPU or processor) 610 and a computing device connection 605 that couples various computing device components including the computing device memory 615, such as read only memory (ROM) 620 and random access memory (RAM) 625, to the processor 610.

The computing device architecture 600 can include a cache of high-speed memory connected directly with, in close proximity to, or integrated as part of the processor 610. The computing device architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other computing device memory 615 may be available for use as well. The memory 615 can include multiple different types of memory with different performance characteristics. The processor 610 can include any general-purpose processor and a hardware or software service stored in storage device 630 and configured to control the processor 610 as well as a special-purpose processor where software instructions are incorporated into the processor design. The processor 610 may be a self-contained system, containing multiple cores or processors, a bus, memory controller, cache, etc. A multi-core processor may be symmetric or asymmetric.

To enable user interaction with the computing device architecture 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art, such as a display, projector, television, speaker device. In some instances, multimodal computing devices can enable a user to provide multiple types of input to communicate with the computing device architecture 600. The communication interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. The storage device 630 can include software, code, firmware, etc., for controlling the processor 610. Other hardware or software modules are contemplated. The storage device 630 can be connected to the computing device connection 605. In one aspect, a hardware module that performs a particular function can include the software component stored in a computer-readable medium in connection with the necessary hardware components, such as the processor 610, connection 605, output device 635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A calibration method, comprising:
capturing a plurality of signals for a plurality of channels, each of the plurality of channels being associated with a pair of transducers formed of a transmitting transducer and a receiving transducer; and
for each of the plurality of channels,
determining a corresponding peak intensity for a corresponding signal of the plurality of signals;
normalizing the corresponding signal based at least on the corresponding peak intensity to yield a corresponding normalized signal; and
applying a time-shift to the normalized signal.

2. The calibration method of claim 1, wherein completing the determining, the normalizing and the applying steps for each of the plurality of channels, reduces a variation in signal intensity across the plurality of channels to be within a threshold.

3. The calibration method of claim 1, wherein normalizing the corresponding signal is based on the peak intensity and a scalar factor.

4. The calibration method of claim 3, wherein applying the scalar factor to the corresponding peak intensity of each of the plurality of channels results in the same peak intensity across the plurality of channels.

5. The calibration method of claim 1, wherein applying the time-shift comprises:
determining a timestamp of a corresponding first dip of the corresponding normalized signal, the time-shift being equal to a difference between measured time of the first dip and an expected value of the time of the first dip.

6. The calibration method of claim 1, wherein the calibration method is performed in a time domain.

7. The calibration method of claim 1, wherein the calibration method is performed for a plurality of pairs of transducers utilized in a testing device for determining a state of health, a state of charge of batteries.

8. The calibration method of claim 7, wherein the calibration method is a digital calibration method performed remotely relative to the testing device.

9. The calibration method of claim 1, wherein the calibration method is performed periodically upon detecting a triggering condition.

10. A device configured to calibrate a plurality of transducers, the device comprising:
one or more memories having computer-readable instructions stored therein; and
one or more processors configured to execute the computer-readable instructions to:
capture a plurality of signals for a plurality of channels, each of the plurality of channels being associated with a pair of transducers formed of a transmitting transducer and a receiving transducer;
determine a corresponding peak intensity for a corresponding signal of the plurality of signals;
normalize the corresponding signal based at least on the corresponding peak intensity to yield a corresponding normalized signal; and
apply a time-shift to the normalized signal.

11. The device of claim 10, wherein determining the corresponding peak intensity, normalizing the corresponding signal, and applying the time-shift for each of the plurality of channels, results in reducing a variation in signal intensity across the plurality of channels to be within a threshold.

12. The device of claim 10, wherein the one or more processors are configured to normalize the corresponding signal based on the peak intensity and a scalar factor.

13. The device of claim 12, wherein the one or more processors are configured to apply the scalar factor to the corresponding peak intensity of each of the plurality of channels to obtain the same peak intensity across the plurality of channels.

14. The device of claim 10, wherein the one or more processors are configured to apply the time-shift by:
determining a timestamp of a corresponding first dip of the corresponding normalized signal, the time-shift being equal to a difference between measured time of the first dip and an expected value of the time of the first dip.

15. The device of claim 10, wherein the one or more processors are configured to perform calibration of the plurality of transducers in a time domain.

16. The device of claim 10, wherein the plurality of transducers are utilized in a testing device for determining a state of health and a state of charge of batteries.

17. The device of claim 16, wherein the one or more processors are configured to digitally calibrate the plurality of transducers.

18. The device of claim 17, wherein the one or more processors are configured to periodically calibrate the plurality of transducers upon detecting a triggering condition.

19. One or more non-transitory computer-readable media comprising computer-readable instructions, which when executed by one or more processors, cause the one or more processors to:
capture a plurality of signals for a plurality of channels, each of the plurality of channels being associated with a pair of transducers formed of a transmitting transducer and a receiving transducer;
determine a corresponding peak intensity for a corresponding signal of the plurality of signals;
normalize the corresponding signal based at least on the corresponding peak intensity to yield a corresponding normalized signal; and
apply a time-shift to the normalized signal.

20. The one or more non-transitory computer-readable media of claim 19, wherein determining the corresponding peak intensity, normalizing the corresponding signal, and applying the time-shift for each of the plurality of channels, results in reducing a variation in signal intensity across the plurality of channels to be within a threshold.
